(19) United States
(12) Patent Application Publication
(10) Pub. No.: US 2024/0174524 A1
(43) Pub. Date: May 30, 2024

(54) METHOD FOR SYNTHESIZING NANO-SIZED ZEOLITE BETA

(71) Applicant: Saudi Arabian Oil Company, Dhahran (SA)

(72) Inventor: Lianhui Ding, Dhahran (SA)

(73) Assignee: Saudi Arabian Oil Company, Dhahran (SA)

(21) Appl. No.: 18/059,705

(22) Filed: Nov. 29, 2022

(51) Int. Cl. C01B 39/48; B01J 29/70; B01J 35/00; B01J 35/10; B01J 37/00; B01J 37/02; B01J 37/03; B01J 37/04; B01J 37/06; B01J 37/08

(52) U.S. Cl. CPC C01B 39/48; B01J 29/7007; B01J 35/0013; B01J 35/1019; B01J 35/1023; B01J 35/1042; B01J 35/1061; B01J 37/0018; B01J 37/0236; B01J 37/036; B01J 37/04; B01J 37/06; B01J 37/08; C01P 2004/03; C01P 2004/64; C01P 2006/12; C01P 2006/14; C01P 2006/16

(57) ABSTRACT

Methods for synthesizing a nano-sized zeolite beta are described. The method may include mixing alumina and tetraethylammonium hydroxide to form an aluminum solution; mixing silica, additional TEAOH, and water to form a silica slurry; and adding the aluminum solution into the silica slurry and mixing to form an aluminosilicate gel. The method may further include transferring the aluminosilicate gel to an autoclave operated at 120° C. to 160° C. for 2 to 4 days at a rotational speed of 60 to 100 rotations per minute to form a zeolite precursor colloid; washing the zeolite precursor colloid with water to form a washed colloid; drying the washed colloid at 80° C. to 150° C. for 6 to 24 hours to form a zeolite precursor; and calcining the zeolite precursor at 400° C. to 650° C. for 2 to 8 hours to form the nano-sized zeolite beta.

### BACKGROUND

### Field

The present disclosure generally relates to nano-sized mesoporous zeolite compositions and the methods of synthesis and use of these compositions, and more specifically, to method for synthesizing a nano-sized zeolite beta using alumina as the aluminum source.

### Technical Background

Beta zeolites are crystallized aluminosilicates that are widely used in heavy oil conversion processes such as hydrocracking and fluid catalytic cracking processes. The feedstock to these processes is a portion of the crude oil that has an initial boiling point of 350 Celsius (° C.) and an average molecular weight ranging from about 200 to 600 or greater. Macroporous materials have pores size distributions between 50 and 1000 nanometers (nm). Mesoporous materials have an intermediate pore size distributions, between 2-50 nm. And, microporous materials exhibit pore size distributions in the range of 0.5-2 nm. Conventional beta zeolites have pore sizes (<2 nm) that do not allow the large molecules to diffuse in and to react on the active sites located inside the zeolites. Increasing pore size and reducing particle size of the zeolites are two effective ways to enhance mass transfer and thus greatly improve catalyst performance.

Nano-sized zeolite beta have been generated, but their synthesis has traditionally utilized expensive elemental aluminum or aluminum isoproxide as the aluminum source of the generated zeolite.

### BRIEF SUMMARY

Accordingly, there is a clear and long-standing need to provide a solution to synthesizing a nano-sized zeolite beta in a more economical manner. The present disclosure addresses such long-standing need by generating nano-sized zeolite beta according to a method which allows for alumina to act as the aluminum source of the generated zeolite. It will be readily appreciated that alumina is readily and cheaply available and thus provides an economical means for generation of nano-sized zeolite beta.

In accordance with one embodiment of the present disclosure, a method for synthesizing a nano-sized zeolite beta includes mixing alumina and tetraethylammonium hydroxide (TEAOH) to form an aluminum solution; mixing silica, additional TEAOH, and water to form a silica slurry; adding the aluminum solution into the silica slurry and mixing for at least 1 hour to form an aluminosilicate gel, where the aluminosilicate gel has a molar ratio composition of 20 to 500 SiO₂: 8 to 300 TEAOH: Al₂O₃: 17 to 700 H₂O; transferring the aluminosilicate gel to an autoclave operated at 120° C. to 160° C. for 2 to 4 days at a rotational speed of 60 to 100 rotations per minute to form a zeolite precursor colloid; washing the zeolite precursor colloid with water to form a washed colloid; drying the washed colloid at 80° C. to 150° C. for 6 to 24 hours to form a zeolite precursor; and calcining the zeolite precursor at 400° C. to 650° C. for 2 to 8 hours to form the nano-sized zeolite beta.

Additional features and advantages of the technology disclosed herein will be set forth in the detailed description which follows, and in part will be readily apparent to those skilled in the art from that description or recognized by practicing the technology as described herein, including the detailed description which follows, as well as the appended claims.

It is to be understood that both the foregoing general description and the following detailed description present embodiments of the technology, and are intended to provide an overview or framework for understanding the nature and character of the technology as it is claimed. Additionally, following descriptions are meant to be merely illustrative, and are not intended to limit the scope of the claims in any manner.

### DETAILED DESCRIPTION

The present disclosure describes various embodiments related to nano-sized mesoporous zeolite compositions and methods of synthesis of these compositions.

The description may use the phrases “in some embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Zeolite catalysts are commonly used in heavy oil conversion processes such as hydrocracking and fluid catalytic cracking processes. For example, crude oil may passed through hydro-treating and then hydrocracking catalysts to remove undesired contents, such as sulfur, nitrogen, and metals, and convert high molecular weight hydrocarbons (complex aromatics or unsaturated hydrocarbons) into naphtha, kerosene, gasoline, diesel oil or high-quality lubricating oils. The catalyst used in hydroprocessing has two functions: cracking of high molecular weight hydrocarbons and hydrogenating the unsaturated molecules. However, the small pore size of the most widely used zeolites in hydrocracking catalysts (zeolite beta and Y) has a negative impact on the performance of the catalyst by preventing the large molecules in the heavy oil fraction from diffusing into the active sites located inside the zeolites. This leads to decreased activity of the catalysts and a possible deactivation of the catalysts. The poor diffusion efficiency of the large molecules can be mitigated by either increasing the pore size of the zeolite catalysts, or reducing the particle size of the zeolite catalysts, or combining both features. Disclosed here are ordered mesoporous zeolite compositions with pore size between 2 and 60 nm and a particle size of less than 100 nm. Reduction in particle size during the synthesis of the zeolite catalysts impacts the performance of the zeolite catalysts by increasing the external surface area of the catalyst and shortening the diffusion path of the reactants and products.

Conventional hydrothermal synthesis of nano-sized beta zeolites suffers from a number of problems associated with the presence of alkali cations during preparation of the same, including irregularity of the zeolite catalyst resulting from aggregation of the nano-sized particles and decreased yield of final products due to the need for ion exchange and separation steps to obtained H-form zeolite product or protonic zeolite forms. Current techniques to overcome the irregularity problem include introduction of a steaming step to a mixture of nano-sized precursors and a micelle solution containing structure directing agents (SDA) or hot alkaline treatments. By controlling SDA concentrations and temperature during the synthesis, nano-sized zeolite particles with ordered mesoporosity were produced. Previous techniques also include the use of ethanolic surfactant solutions for flocculation and this leads to the need for a subsequent filtration process to separate the zeolites.

Previous methods of synthesizing nano-sized beta zeolite have also conventionally utilized expensive aluminum sources such as metallic aluminum or aluminum isoproxide. However, embodiments in accordance with the present disclosure have demonstrated synthesis of nano-sized beta zeolite with a significantly cheaper aluminum source, alumina (Al₂O₃).

Disclosed here are specific methods of synthesis of these nano-sized mesoporous zeolite compositions. In accordance with the present disclosure, a method for synthesizing a nano-sized zeolite beta comprises mixing alumina and tetraethylammonium hydroxide (TEAOH) to form an aluminum solution; mixing silica, additional TEAOH, and water to form a silica slurry; and adding the aluminum solution into the silica slurry and mixing for at least 1 hour to form an aluminosilicate gel, where the aluminosilicate gel has a molar ratio composition of 20 to 500 SiO₂: 15 to 40 TEAOH: Al₂O₃: 17 to 700 H₂O. Subsequently, the aluminosilicate gel is transfer to an autoclave operated at 120° C. to 160° C. for 2 to 4 days at a rotational speed of 60 to 100 rotations per minute to form a zeolite precursor colloid; the zeolite precursor colloid is washed with water to form a washed colloid; the washed colloid is dried at 80° C. to 150° C. for 6 to 24 hours to form a zeolite precursor. Finally, the zeolite precursor is calcined at 400° C. to 650° C. for 2 to 8 hours to form the nano-sized zeolite beta. The method of synthesizing nano-sized zeolite beta and each distinct step is discussed in further infra.

These compositions are ultimately synthesized from a mixture of fumed or colloidal silica with alumina. The methods do not include the use of aluminum or silica salts to form the zeolite precursors. The nano-sized zeolite beta can be H-form mesoporous nano-sized beta zeolites. The nano-sized zeolite beta combines the advantages of mesoporous materials and nano-sized particles. In this method, there is no introduction of sodium ions or other impurities and as such, the methods according to embodiments of the present disclosure also eliminate the need for a subsequent ion-exchange step, such as an exchange of ammonium ions. The dry gel conversion improves the efficiency of synthesis and product yields as the elimination of post ion-exchange as in conventional methods eliminates loss of zeolite during sodium ion removal.

In one or more embodiments, an aluminum solution is formed. Specifically, alumina and tetraethylammonium hydroxide (TEAOH) are mixed to form the aluminum solution. As previously indicated, the source of aluminum in the aluminum solution is alumina which provides substantial cost savings compared to conventionally utilized expensive aluminum sources such as metallic aluminum or aluminum isoproxide. It will be appreciated that the formation pathway to generate aluminate (AlO₂⁻), an intermediary in the generation of zeolite, is different depending on the source of aluminum. For example, Reaction 1 illustrates the pathway for generation of aluminate from elemental aluminum as compared to Reaction 2 which illustrates the pathway for generation of aluminate from alumina. It is noted that nuclei formation and crystal growth of zeolites is generally via a via liquid mechanism where the silicon and aluminum precursors are dissolved in solution, first generate nuclei, and then silicon and aluminum species transferred to the nuclei to make the crystal grow. Therefore, the difference in Al and Al₂O₃ dissolution in the base solution can lead to the rate of zeolite nuclei formation and crystallization.

Al+OH⁻→Al(OH)₃+OH⁻→AlO₂⁻ Reaction 1

Al₂O₃+OH⁻→AlO₂⁻ Reaction 2

In one or more embodiments, a silica slurry is formed. Specifically, silica is mixed with additional tetraethylammonium hydroxide (TEAOH) and water to form the silica slurry. In an embodiment, the silica source is fumed silica. In another embodiment, the silica source is colloidal silica. Use of these silica sources instead of alkali salts of silica, and use of alumina instead of the alkali salts of aluminum, eliminates the need for a subsequent ion exchange step and leads to the direct formation of the beta zeolite product.

In one or more embodiments, the aluminum solution is added into the silica slurry and mixing to form an aluminosilicate gel. The aluminum solution and the silica slurry may be mixed for at least 1 hour, at least 1.5 hours, at least 2 hours, or at least 3 hours in various embodiments. It will be appreciated that mixing time must be sufficient to completely integrate the aluminum solution and the silica slurry and to generate a gel.

Generation of the aluminum solution and the silica slurry is completed such that the aluminosilicate gel has a molar ratio composition of 20 to 500 SiO₂: 8 to 300 TEAOH: Al₂O₃: 17 to 700 H₂O. Specifically, as the aluminum solution and the silica slurry are combined to form the aluminosilicate gel the relative ratios of silica, TEAOH, alumina, and water in each of the aluminum solution and the silica slurry may be appreciated. For example, for each mole of alumina forming the aluminum solution 20 to 500 moles of silica should be utilized to form the silica slurry. In further embodiments, the aluminosilicate gel may have a molar ratio composition of 20 to 500 SiO₂: 8 to 300 TEAOH: Al₂O₃: 17 to 700 H₂O. In yet further embodiments, the aluminosilicate gel may have a molar ratio composition of 20-100 SiO₂: 8-60 TEAOH: Al₂O₃: 200-500 H₂O.

In one or more embodiments, the aluminosilicate gel is transferred to an autoclave to form a zeolite precursor colloid. It will be appreciated that heating in the autoclave forms zeolite nuclei from the silicon and aluminum species which are then crystallized to form zeolite crystals.

In various embodiments, the aluminosilicate gel is heated in the autoclave operated at 120° C. to 160° C., 125° C. to 155° C., 130° C. to 150° C., 135° C. to 145° C., or approximately 140° C. Further, in various embodiments, the aluminosilicate gel may be heated in the autoclave for 2 to 4 days, 2.5 to 4 days, 2 to 3.5 days, 2.5 to 3.5 days, or approximately 3 days. Additionally, in various embodiments, the aluminosilicate gel may be rotated in the autoclave at a rotational speed of 60 to 100 rotations per minute (rpm), 60 to 90 rpm, 60 to 80 rpm, 60 to 70 rpm, or approximately 60 rpm.

In one or more embodiments, the autoclave is quenched with water. It will be appreciated that quenching abruptly stops any reaction in the autoclave and ensures the reaction time for all syntheses remain the same across multiple production runs. It will also be appreciated, that the water used to quench the autoclave is not necessarily limited to distilled water and tap or purified water may be utilized as the quenching water does not make contact with the aluminosilicate gel or generated zeolite precursor colloid. In one or more embodiments, the water may be cold water which for purposes of the present disclosure is defined as water at or less than 30° C. In various embodiments, the autoclave may be quenched for 1 hour, 1.5 hours, 2 hours, 3 hours, or 4 hours.

Conventional methods of preparation of nano-sized zeolites include the use of ethanol or an ethanolic surfactant solution to harvest the zeolite precursors and these conditions include longer stirring time with no adjustment of pH. This leads to the formation of flocculants that have to be filtered before subsequent processing. During the filtration process, a considerable amount of silica and aluminum species are removed. So, a subsequent hydrothermal treatment results in a localized formation of zeolites. The crystallinity of the zeolite decreases, and most of them are amorphous materials and not zeolite. In embodiments of the methods disclosed here, the first step is the formation of the zeolite precursor building units as the aluminosilicate gel. There is no separation step, so all silica and aluminum species remain in the system. After the hydrothermal treatment, almost all silica and aluminum are converted to beta zeolite instead of being flushed from the system.

In one or more embodiments, the zeolite precursor colloid generated from heating in the autoclave is washed with water to form a washed colloid. The water used to wash the zeolite precursor colloid is preferably distilled water to avoid reaction or contamination of the resulting washed colloid. However, it will be appreciated that any purified water without impurities such as Mg, Na, Ca, Cl can be utilized and that distilled water is not required in all embodiments. Such impurities, and especially Mg, Ca, Na cations, can be deposited on the zeolite to neutralize the acidic sites, and thus reduce the zeolite acidity, as well as potentially reduce the zeolite stability. Washing the zeolite precursor colloid removes any silica, TEAOH, alumina, silica, or other undesirable reaction products from the desired products to generate the zeolite beta or crystallized SiO₂—Al₂O₃. If the alumina and silica species are not removed, they will become amorphous silica-alumina after drying and calcination, and thus decrease the final product crystallinity and zeolite purity.

In one or more embodiments, washing the zeolite precursor colloid with water to form the washed colloid comprises separating the solid and colloid products from the autoclave from any liquid products formed in the autoclave with a centrifuge. The solid and colloid products are then mixed with the water to wash the solid and colloid products. Water may be added to the solid and colloid products at about a 10:1 weight ratio of water to products and the mixture may be stirred for approximately 30 minutes. The resulting solution is then separated with the centrifuge. In various embodiments, the washing and separation may be repeated for a total of 1, 2, 3, 4, or 5 washings. Alternatively, the washing and separation may be repeated until the resulting solution removed during centrifugation has a pH of less than 9.0. Specifically, after centrifuge, the solid product is settled at the bottom of the centrifuge tube and at the top of the tube a clear solution is present which represents the resulting solution having a pH of less than 9.0.

In one or more embodiments, the washed colloid is dried to form a zeolite precursor. In various embodiments, the washed colloid may be dried at an elevated drying temperature of 80° C. to 150° C., 90° C. to 150° C., 100° C. to 150° C., 110° C. to 150° C., 80° C. to 140° C., 80° C. to 130° C., 80° C. to 120° C., 90° C. to 120° C., or 100° C. to 110° C. Further, in various embodiments, the washed colloid may be dried at the elevated drying temperature for a period of 6 to 24 hours, 10 to 24 hours, 12 to 24 hours, 6 to 18 hours, or 8 to 14 hours. Alternatively, the period of drying at the elevated drying temperature may be considered overnight.

In one or more embodiments, the zeolite precursor is calcined to form the nano-sized zeolite beta. In various embodiments, the zeolite precursor may be calcined at an elevated calcining temperature of 400° C. to 650° C., 450° C. to 650° C., 500° C. to 650° C., 550° C. to 650° C., 500° C. to 600° C., or 550° C. to 600° C. Further, in various embodiments, the zeolite precursor may be calcined at the elevated calcining temperature for a period of 2 to 8 hours, 2 to 6 hours, 3 to 6 hours, 4 to 8 hours, 4 to 5 hours, or approximately 4 hours. In one or more embodiments, the ramp rate during calcining is 2° C. per minute.

Properties of the nano-sized zeolite beta include an average particle size ranging from 10 nm to 100 nm. The average particle size is based on SEM measurement. In some embodiments, the nano-sized zeolite beta have a particle size ranging from 10 nm to 90 nm, 20 nm to 100 nm, 30 nm to 100 nm, 40 nm to 100 nm, or 50 nm to 100 nm. The surface area of the nano-sized zeolite beta can range from 500 square meters per gram (m²/g) to 800 m²/g. In some embodiments, the nano-sized zeolite beta can range from 500 m²/g to 700 m²/g, 500 m²/g to 600 m²/g, 550 m²/g to 800 m²/g, or 550 m²/g to 700 m²/g. The pore volume of the nano-sized zeolite beta can range from 0.5 milliliters per gram (ml/g) to 1.0 ml/g. In some embodiments, the pore volume of the nano-sized zeolite beta can range from 0.6 ml/g to 1.0 ml/g, 0.75 ml/g to 1.0 ml/g, 0.5 ml/g to 0.9 ml/g, or 0.75 ml/g to 0.9 ml/g. The pore sizes of the nano-sized zeolite beta can range from 3 nm to 10 nm. In some embodiments, the pore sizes of the nano-sized zeolite beta can range from 3 nm to 8 nm, 4 nm to 10 nm, 4 nm to 8 nm, or 5 nm to 7 nm. The pore size may be determined from the surface area using Brunauer-Emmett-Teller technique and pore volume.

Embodiments of the presently disclosed methods for synthesizing a nano-sized zeolite beta do not require the step of removal of alkali cations, as sodium or other cations, as such species are not introduced to form the initial aluminosilicate mixture. As the silica source is either fumed silica or colloidal silica, this method eliminates the need for a subsequent ion-exchange step. Moreover, alumina is used in place of elemental aluminum or other more expensive species. As one or more steps from a conventional zeolite process are eliminated and cheaper starting materials are utilized, the cost of synthesis of the zeolites decreases in combination with an increase in the yield of the zeolites.

### EXAMPLES

The methods for synthesizing a nano-sized zeolite beta will be further clarified by the following examples. The examples are illustrative in nature, and should not be understood to limit the subject matter of the present disclosure.

Two samples of nano-sized zeolite beta were prepared to compare synthesis via a conventional method and synthesis in accordance with methods of the present disclosure. The synthesis of nano-sized zeolite beta using a conventional aluminum source is presented as Comparative Example 1. The synthesis of nano-sized zeolite beta using a alumina as the aluminum source is presented as Inventive Example 2.

### Comparative Example 1

In accordance with conventional methods, elemental aluminum powder was utilized in the preparation of nano-sized zeolite beta for comparative example 1. In a first vessel, 0.27 grams of metal Al powder from Sigma Aldrich was combined with 25 grams tetraethylammonium hydroxide (TEAOH) (Aldrich, 35% aqueous solution). The resulting mixture was stirred at room temperature until the Al powder was completely dissolved and formed a clear solution. In a second vessel, 15 grams of fumed silica (Aerosil® 200 from Evonik Industries AG (Essen, Germany)) was combined with 38 grams of 35% TEAOH and 4.05 grams of purified water to form a slurry. The aluminum solution in the first vessel was then added into the slurry in the second vessel and mixed at room temperature for 4 hours to form an aluminosilcate gel. The aluminosilicate gel was subsequently transferred into a PTFE lined stainless steel autoclave, sealed, and put into a rotating oven. The autoclave was rotated at 60 rpm at 140° C. for three days and then quenched with cold water for 1 hour. The colloid formed in the autoclave was then washed in a high-speed centrifuge in a repeated manner until a pH of about 9.0 was reached. The solid zeolite products were then dried at 110° C. overnight, and calcined at 550° C. for 4 hours at a ramp of 2° C. per minute.

### Inventive Example 2

In accordance with embodiments of the present disclosure, alumina was utilized in the preparation of nano-sized zeolite beta for inventive example 2. In a first vessel, 0.51 grams of alumina (Catapal®, Sasol) was combined with 25 grams tetraethylammonium hydroxide (TEAOH) (Aldrich, 35% aqueous solution). The resulting mixture was stirred at room temperature until the alumina was completely dissolved and formed a clear solution. In a second vessel, 15 grams of fumed silica Aerosil® 200 from Evonik Industries AG (Essen, Germany)) was combined with 38 grams of 35% TEAOH and 4.05 grams of purified water to form a slurry. The aluminum solution in the first vessel was then added into the slurry in the second vessel and mixed at room temperature for 4 hours to form an aluminosilcate gel. The aluminosilicate gel was subsequently transferred into a PTFE lined stainless steel autoclave, sealed, and put into a rotating oven. The autoclave was rotated at 60 rpm at 140° C. for three days and then quenched with cold water for 1 hour. The colloid formed in the autoclave was then washed in a high-speed centrifuge in a repeated manner until a pH of about 9.0 was reached. The solid zeolite products were then dried at 110° C. overnight, and calcined at 550° C. for 4 hours at a ramp of 2° C. per minute.

The properties of the nano-size zeolite beta of both Comparative Example 1 and Inventive Example 2 are presented below in Table 1. The average particle size is based on SEM measurement. The average pore sizes were determined from the surface area using Brunauer-Emmett-Teller (BET) technique and pore volume. The XRD crystallinity was determined with CP-814E (Zeolyst International) used as the reference.

TABLE 1
Nano-Sized Zeolite Beta Properties

| | Comparative | Inventive |
|---|---|---|
| | Example 1 | Example 2 |
| Aluminum Source | Elemental Al | Al₂O₃ |
| Si:Al₂ (molar) | 25 | 25 |
| XRD crystallinity | 95.0 | 94.8 |
| SEM average particle size, nm | 80 | 83 |
| BET surface area, m²/g | 596 | 592 |
| Pore volume, ml/g | 0.81 | 0.83 |
| Average pore size, nm | 5.44 | 5.61 |

As shown in Table 1, the zeolites prepared via conventional synthesis method (Comparative Example 1) were similar to the zeolites prepared via the methods in accordance with the present disclosure (Inventive Example 2). As such, it is demonstrated that alumina may be utilized as a lower cost alternative to elemental aluminum as the aluminum source to generate nano-sized zeolite beta.

Based on the foregoing, it should now be understood that various aspects of method and systems for producing aromatics and light olefins from a mixed plastics stream are disclosed herein.

According to a first aspect of the present disclosure, a method for synthesizing a nano-sized zeolite beta comprises mixing alumina and tetraethylammonium hydroxide (TEAOH) to form an aluminum solution; mixing silica, additional TEAOH, and water to form a silica slurry; adding the aluminum solution into the silica slurry and mixing for at least 1 hour to form an aluminosilicate gel, where the aluminosilicate gel has a molar ratio composition of 20 to 500 SiO₂: 8 to 300 TEAOH: Al₂O₃: 17 to 700 H₂O; transferring the aluminosilicate gel to an autoclave operated at 120° C. to 160° C. for 2 to 4 days at a rotational speed of 60 to 100 rotations per minute to form a zeolite precursor colloid; washing the zeolite precursor colloid with water to form a washed colloid; drying the washed colloid at 80° C. to 150° C. for 6 to 24 hours to form a zeolite precursor; and calcining the zeolite precursor at 400° C. to 650° C. for 2 to 8 hours to form the nano-sized zeolite beta.

A second aspect includes the method of the first aspect, in which the nano-sized zeolite beta comprises an average particle size, based on SEM measurement, of 10 to 100 nanometers.

A third aspect includes the method of the first or second aspects, in which the nano-sized zeolite beta comprises a surface area, based on BET measurement, of 500 to 800 m²/g.

A fourth aspect includes the method of any of the first through third aspects, in which the nano-sized zeolite beta comprises a pore volume of 0.5 to 1.0 ml/g.

A fifth aspect includes the method of any of the first through fourth aspects, in which the nano-sized zeolite beta comprises an average pore size of 3 to 10 nm.

A sixth aspect includes the method of any of the first through fifth aspects, in which the autoclave is quenched with cold water prior to washing the zeolite precursor colloid with water.

A seventh aspect includes the method of any of the first through sixth aspects, in which washing the zeolite precursor colloid with water to form the washed colloid is completed in a centrifuge.

An eighth includes the method of any of the first through seventh aspects, in which the washed colloid comprises a pH of about 9.0.

A ninth aspect includes the method of any of the first through eighth aspects, in which the silica is fumed silica.

A tenth aspect includes the method of any of the first through eighth aspects, in which the silica is colloidal silica.

An eleventh aspect includes the method of any of the first through tenth aspects, in which the autoclave is operated at 130° C. to 150° C. for 2 to 4 days at a rotational speed of 60 to 80 rotations per minute.

A twelfth aspect includes the method of any of the first through eleventh aspects, in which the washed colloid is dried at 100° C. to 110° C.

A thirteenth aspect includes the method of any of the first through twelfth aspects, in which the zeolite precursor is calcined at 550° C. to 600° C. for 3 to 6 hours to form the nano-sized zeolite beta.

A fourteenth aspect includes the method of any of the first through thirteenth aspects, in which the ramp rate during calcining is 2° C. per minute.

A fifteenth aspect includes the method of any of the first through fourteenth aspects, in which the aluminosilicate gel has a molar ratio composition of 20 to 500 SiO₂: 15 to 40 TEAOH: Al₂O₃: 17 to 700 H₂O.

A sixteenth aspect includes the method of any of the first through fourteenth aspects, in which the aluminosilicate gel has a molar ratio composition of the aluminosilicate gel has a molar ratio composition of 20-100 SiO₂: 8-60 TEAOH: Al₂O₃: 200-500 H₂O.

It should be apparent to those skilled in the art that various modifications and variations can be made to the described embodiments without departing from the spirit and scope of the claimed subject matter. Thus, it is intended that the specification cover the modifications and variations of the various described embodiments provided such modifications and variations come within the scope of the appended claims and their equivalents.

The singular forms “a”, “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned. For brevity, the same is not explicitly indicated subsequent to each disclosed range and the present general indication is provided. Further, it should be understood that any two quantitative values assigned to a property may constitute a range of that property, and all combinations of ranges formed from all stated quantitative values of a given property are contemplated in this disclosure.

As used in this disclosure and in the appended claims, the words “comprise,” “has,” and “include” and all grammatical variations thereof are each intended to have an open, non-limiting meaning that does not exclude additional elements or steps.

Throughout the present description description, numerous details are set forth in order to provide a thorough understanding of the various embodiments. In other instances, well-known processes, devices, and systems may not been described in particular detail in order not to unnecessarily obscure the various embodiments, but such would be obtainable by one skilled in the art. Additionally, illustrations of the various embodiments may omit certain features or details in order to not obscure the various embodiments.

What is claimed is:

1. A method for synthesizing a nano-sized zeolite beta, the method comprising:
mixing alumina and tetraethylammonium hydroxide (TEAOH) to form an aluminum solution;
mixing silica, additional TEAOH, and water to form a silica slurry;
adding the aluminum solution into the silica slurry and mixing for at least 1 hour to form an aluminosilicate gel, where the aluminosilicate gel has a molar ratio composition of 20 to 500 SiO₂: 8 to 300 TEAOH: Al₂O₃: 17 to 700 H₂O;
transferring the aluminosilicate gel to an autoclave operated at 120° C. to 160° C. for 2 to 4 days at a rotational speed of 60 to 100 rotations per minute to form a zeolite precursor colloid;
washing the zeolite precursor colloid with water to form a washed colloid;
drying the washed colloid at 80° C. to 150° C. for 6 to 24 hours to form a zeolite precursor; and
calcining the zeolite precursor at 400° C. to 650° C. for 2 to 8 hours to form the nano-sized zeolite beta.

2. The method of claim 1, wherein the nano-sized zeolite beta comprises an average particle size, based on SEM measurement, of 10 to 100 nanometers.

3. The method of claim 1, wherein the nano-sized zeolite beta comprises a surface area, based on BET measurement, of 500 to 800 m²/g.

4. The method of claim 1, wherein the nano-sized zeolite beta comprises a pore volume of 0.5 to 1.0 ml/g.

5. The method of claim 1, wherein the nano-sized zeolite beta comprises an average pore size of 3 to 10 nm.

6. The method of claim 1, wherein the autoclave is quenched with cold water prior to washing the zeolite precursor colloid with water.

7. The method of claim 1, wherein washing the zeolite precursor colloid with water to form the washed colloid is completed in a centrifuge.

8. The method of claim 1, wherein the washed colloid comprises a pH of about 9.0.

9. The method of claim 1, wherein the silica is fumed silica.

10. The method of claim 1, wherein the silica is colloidal silica.

11. The method of claim 1, wherein the autoclave is operated at 130° C. to 150° C. for 2 to 4 days at a rotational speed of 60 to 80 rotations per minute.

12. The method of claim 1, wherein the washed colloid is dried at 100° C. to 110° C.

13. The method of claim 1, wherein the zeolite precursor is calcined at 550° C. to 600° C. for 3 to 6 hours to form the nano-sized zeolite beta.

14. The method of claim 1, wherein the ramp rate during calcining is 2° C. per minute.

15. The method of claim 1, wherein the aluminosilicate gel has a molar ratio composition of 20 to 500 SiO₂: 15 to 40 TEAOH: Al₂O₃: 17 to 700 H₂O.

16. The method of claim 1, wherein the aluminosilicate gel has a molar ratio composition of 20-100 SiO₂: 8-60 TEAOH: Al₂O₃: 200-500 H₂O.
